(19) United States
(12) Patent Application Publication
(10) Pub. No.: US 2025/0326080 A1
(43) Pub. Date: Oct. 23, 2025

(54) MACHINE TOOL CONTROL DEVICE AND NON-TRANSITORY COMPUTER-READABLE STORAGE MEDIUM

(71) Applicant: FANUC CORPORATION, Minamitsuru-gun, Yamanashi (JP)

(72) Inventor: Toshihiro WATANABE, Yamanashi (JP)

(73) Assignee: FANUC CORPORATION, Minamitsuru-gun, Yamanashi (JP)

(21) Appl. No.: 18/866,348

(22) PCT Filed: Jul. 13, 2022
(86) PCT No.: PCT/JP2022/027518

§ 371 Date: Nov. 15, 2024

(51) Int. Cl. B23Q 15/12

(52) U.S. Cl. CPC B23Q 15/12

(57) ABSTRACT

A machine tool control device 100: causes a machine tool 200 to relatively move a workpiece 260 and a cutting tool 220 and thereby execute a cutting operation for cutting the workpiece 260; and causes chips to be broken up by superimposing relative vibration onto the relative movement of the cutting tool 220 and the workpiece 260 so as to generate air cuts. An acquisition unit 10 acquires association information αβ that indicates an association between a cutting condition α that indicates a mode of cutting operation and a vibration condition β that includes the amplitude and/or frequency of the relative vibration. A selection unit 20 recognizes the cutting condition α for a cutting operation that is to be executed and selects the vibration condition β on the basis of the recognized cutting condition α and the correspondence information αβ. The machine tool control device 100 superimposes the relative vibration onto the relative movement of the cutting tool 220 and the workpiece 260 on the basis of the selected vibration condition β.

### TECHNICAL FIELD

The present invention relates to a machine tool control device for controlling a machine tool.

### BACKGROUND ART

Some machine tool control devices cause a machine tool to execute a cutting operation for cutting a workpiece by creating relative movement between the workpiece and a cutting tool, and also to break up chips by superimposing relative vibration on the relative movement between the workpiece and the cutting tool, and thus generating air cutting.

### CITATION LIST

### Patent Document

Patent Document 1: Japanese Patent No. 5033929

### DISCLOSURE OF THE INVENTION

### Problems to be Solved by the Invention

Such chip breaking by air cutting can either be sufficiently accomplished or insufficiently accomplished depending on variations in cutting conditions, such as the feed direction and the feedrate in the relative movement, the cutting tool posture, or the depth of cut, even if the relative vibration is superimposed thereon under the same vibration condition, such as with the same amplitude and the same frequency.

However, setting the amplitude so high as to sufficiently accomplish the chip breaking regardless of the cutting conditions, for example, leads not only to increased unnecessary motion in the relative vibration but also to increased unnecessary damage to the cutting tool, the workpiece, the machine tool, and the like. Furthermore, it requires significant effort from a user to, for example, input commands for changing vibration conditions at respective points in a program command to set a parameter such as the amplitude to a larger value specifically for locations where a cutting condition makes it difficult to break up the chips and to set the parameter such as the amplitude to a smaller value for other locations.

The present disclosure has been made in view of the circumstances described above, and an object thereof is to make it possible to set just the right vibration condition, while reducing effort required from the user.

### Means for Solving the Problems

The present disclosure provides a machine tool control device for causing a machine tool to execute a cutting operation for cutting a workpiece by creating relative movement between the workpiece and a cutting tool, and also to break up chips by superimposing relative vibration between the workpiece and the cutting tool on the relative movement, and thus generating air cutting, the machine tool control device including:
an acquisition unit that acquires association information indicating associations between cutting conditions each indicating a factor of the cutting operation and vibration conditions each including at least one of an amplitude or a frequency of the relative vibration; and
a selection unit that recognizes a cutting condition set for the cutting operation to be executed and selects a vibration condition from among the vibration conditions based on the recognized cutting condition and the association information, wherein
the relative vibration is superimposed on the relative movement based on the selected vibration condition.

The present disclosure also provides a machine tool control program for enabling a computer to function as a machine tool control device for causing a machine tool to execute a cutting operation for cutting a workpiece by creating relative movement between the workpiece and a cutting tool, and also to break up chips by superimposing relative vibration between the workpiece and the cutting tool on the relative movement, and thus generating air cutting, the machine tool control program being configured to further enable the computer to function as:
an acquisition unit that acquires association information indicating associations between cutting conditions each indicating a factor of the cutting operation and vibration conditions each including at least one of an amplitude or a frequency of the relative vibration; and
a selection unit that recognizes a cutting condition set for the cutting operation to be executed and selects a vibration condition from among the vibration conditions based on the recognized cutting condition and the association information, wherein
the relative vibration is superimposed on the relative movement based on the selected vibration condition.

The present disclosure makes it possible to set just the right vibration condition, while reducing effort required from the user.

### BRIEF DESCRIPTION OF THE DRAWINGS

FIG. 1 is a configuration diagram illustrating a machine tool control device according to a first embodiment;

FIG. 2 is a side view of a cutting tool and a workpiece;

FIG. 3 is a graph showing paths of the cutting tool in a case where relative vibration is superimposed on relative movement;

FIG. 4 is a configuration diagram illustrating a machine tool control program;

FIG. 5 is a flowchart showing a flow of a first specific example;

FIG. 6 is a flowchart showing a flow of a second specific example;

FIG. 7 is a flowchart showing a flow of a third specific example;

FIG. 8 is a flowchart showing a flow of a fourth specific example;

FIG. 9 is a flowchart showing a flow of a fifth specific example;

FIG. 10 is a flowchart showing a flow of a sixth specific example;

FIG. 11 is a flowchart showing a flow of a seventh specific example;

FIG. 12 is a flowchart showing a flow of an eighth specific example;

FIG. 13 is a flowchart showing a flow of a ninth specific example;

FIG. 14 is a flowchart showing a flow of a tenth specific example;

FIG. 15 is a flowchart showing a flow of an eleventh specific example;

FIG. 16 is a diagram showing examples of program commands;

FIG. 17 is a diagram showing association information according to a second embodiment;

FIG. 18 is a flowchart showing a flow of selection by a selection unit; and

FIG. 19 is a diagram showing an example of program commands.

### PREFERRED MODE FOR CARRYING OUT THE INVENTION

The following describes embodiments of the present disclosure with reference to the drawings. However, the present disclosure is not in any way limited to the following embodiments, and appropriate modifications can be made within the scope of the gist of the present disclosure.

### First Embodiment

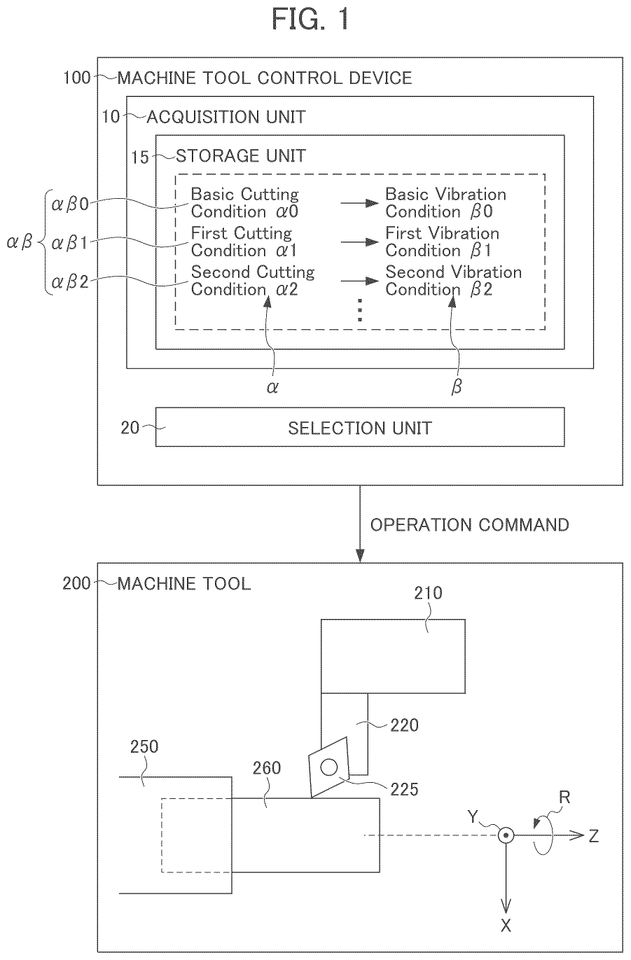

First, with reference to FIGS. 1 to 3, the following describes a machine tool control device 100 according to a first embodiment and a machine tool 200 that is controlled by the machine tool control device 100. Hereinafter, three predetermined directions that are orthogonal to each other are referred to as “X direction”, “Y direction”, and “Z direction”. Specifically, for example, the X direction is the vertical direction, and the Y direction and the Z direction are horizontal directions that are orthogonal to each other.

The machine tool 200 has a tool holding unit 210 that holds a cutting tool 220 and a workpiece holding unit 250 that holds a workpiece 260. Hereinafter, the cutting tool 220 and the workpiece 260 are referred to as “two entities 220 and 260”. The machine tool 200 is configured to create relative movement between the two entities 220 and 260. The relative movement includes relative X-axis movement, relative Y-axis movement, relative Z-axis movement, and relative Z-axis rotation.

Specifically, the machine tool 200 creates, for example, the relative X-axis movement by moving the tool holding unit 210 in the X direction. Alternatively or additionally, the machine tool 200 may create the relative X-axis movement by moving the workpiece holding unit 250 in the X direction. The machine tool 200 creates, for example, the relative Y-axis movement by moving the tool holding unit 210 in the Y direction. Alternatively or additionally, the machine tool 200 may create the relative Y-axis movement by moving the workpiece holding unit 250 in the Y direction. The machine tool 200 creates, for example, the relative Z-axis movement by moving the workpiece holding unit 250 in the Z direction. Alternatively or additionally, the machine tool 200 may create the relative Z-axis movement by moving the tool holding unit 210 in the Z direction. The machine tool 200 creates the relative Z-axis rotation by causing the workpiece holding unit 250 to make revolutions R around the Z axis. Alternatively or additionally, the machine tool 200 may create the relative Z-axis rotation by causing the tool holding unit 210 to make revolutions R around the Z axis.

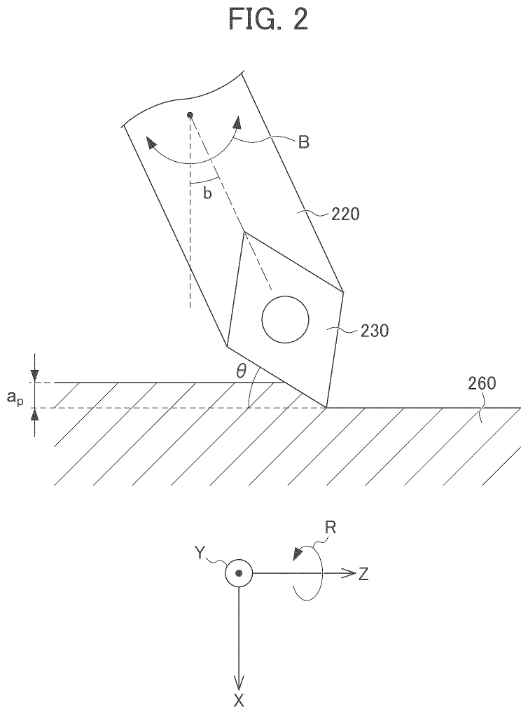

As shown in FIG. 2, the relative angle of the cutting tool 220 with respect to the workpiece 260 is referred to below as a “tool angle b”. That is, the tool angle b refers to the angle indicating the relative posture of the cutting tool 220 with respect to the workpiece 260. Specifically, the tool angle b refers to the angle of the axis of the cutting tool 220 with respect to the normal direction to a surface of the workpiece 260. The angle of the surface of the workpiece 260 with respect to a side surface of a cutting edge of a blade 230 of the cutting tool 220 is referred to below as an “approach angle θ”. The depth at which the cutting tool 220 cuts the workpiece 260 is referred to below as a “depth of cut aₚ”. The machine tool 200 is configured to allow the cutting tool 220 to revolve in a predetermined tool revolving direction B by operating the tool holding unit 210. The tool angle b and the approach angle θ are changed through the revolving.

The machine tool control device 100 shown in FIG. 1 controls the machine tool 200 based on a program command Co inputted by a user. Specifically, the machine tool control device 100 causes the machine tool 200 to execute a cutting operation on the workpiece 260 by creating the relative movement between the two entities 220 and 260. As a result of the cutting operation, chips are generated from the workpiece 260.

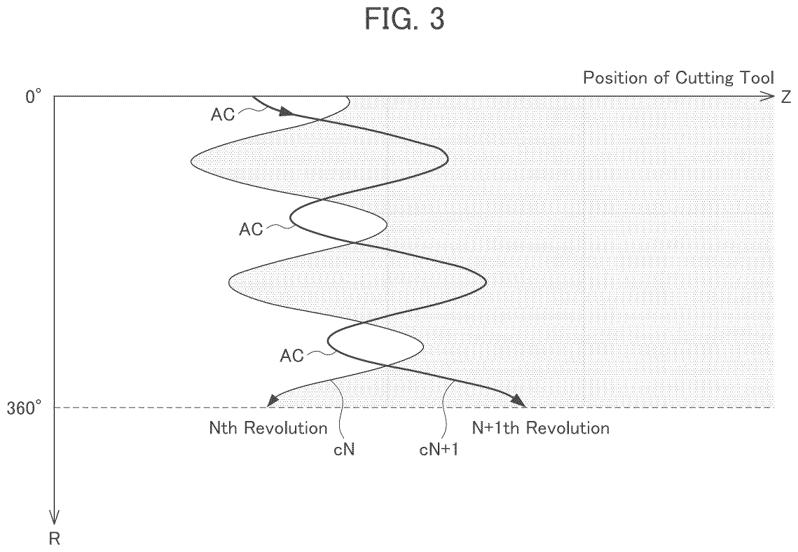

The machine tool control device 100 therefore superimposes relative vibration between the two entities 220 and 260 on the cutting operation to intermittently generate air cutting AC in which the cutting tool 220 does not cut the workpiece 260 as shown in FIG. 3. Through the air cutting AC, the chips from the workpiece 260 are broken up. The relative vibration is motion that causes the relative positions of the two entities 220 and 260 to move back and forth in a predetermined direction. Specific examples of the superimposition of the relative vibration include a case where the machine tool 200 creates relative vibration between the two entities 220 and 260 in the Z direction while creating the relative Z-axis rotation and the relative Z-axis movement, with the blade 230 of the cutting tool 220 in contact with the workpiece 260.

In this case, preferably, a cutting path cN+1 of the N+1th revolution of the cutting tool 220 on the workpiece 260 is shifted by exactly half a wavelength with respect to a cutting path cN of the Nth revolution. As a result, the cutting path cN+1 of the N+1th revolution effectively intersects with the cutting path cN of the Nth revolution, efficiently generating the air cutting AC.

In order to superimpose just the right relative vibration, as shown in FIG. 1, the machine tool control device 100 has an acquisition unit 10 and a selection unit 20. A condition that indicates a factor of the cutting operation on the workpiece 260 is referred to below as a “cutting condition α”. A condition that indicates a factor of the relative vibration between the two entities 220 and 260 is referred to below as a “vibration condition β”. Information that indicates an association between the cutting condition α and the vibration condition β is referred to below as “association information αβ”.

The cutting condition α includes at least one of the feed direction in the relative movement between the two entities 220 and 260, the feedrate in the relative movement, the cutting speed of the workpiece 260, the tool angle b, the approach angle θ, the depth of cut aₚ, the type of the cutting tool 220, the type of the workpiece 260, or the mode of the machine tool 200. The vibration condition β includes at least one of an amplitude A or a frequency f of the relative vibration.

The acquisition unit 10 has a storage unit 15. The acquisition unit 10 acquires the association information αβ and stores the acquired association information αβ in the storage unit 15. The acquisition unit 10 may acquire the association information αβ, for example, by accessing to the association information αβ through a network or the like, by receiving the association information of inputted by the user, or by accessing to the association information αβ in a recording medium. The storage unit 15 may be volatile memory such as DRAM, but is preferably nonvolatile memory such as SRAM.

The association information αβ includes, for example, basic association information αβ0, first association information αβ1, second association information αβ2, and so on. The basic association information αβ0 associates a predetermined basic cutting condition α0 with a predetermined basic vibration condition β0. The first association information αβ1 associates a first cutting condition α1, which is different from the basic cutting condition α0, with a predetermined first vibration condition β1. The second association information αβ2 associates a second cutting condition α2, which is different from both the basic cutting condition α0 and the first cutting condition α1, with a predetermined second vibration condition β2.

The selection unit 20 recognizes a cutting condition α set for the cutting operation that is yet to be executed, based on the program command Co inputted by the user. The selection unit 20 then selects a vibration condition β associated with the recognized cutting condition α based on the recognized cutting condition α and the association information αβ stored in the storage unit 15. The machine tool control device 100 superimposes the relative vibration on the relative movement between the two entities 220 and 260 based on the selected vibration condition β.

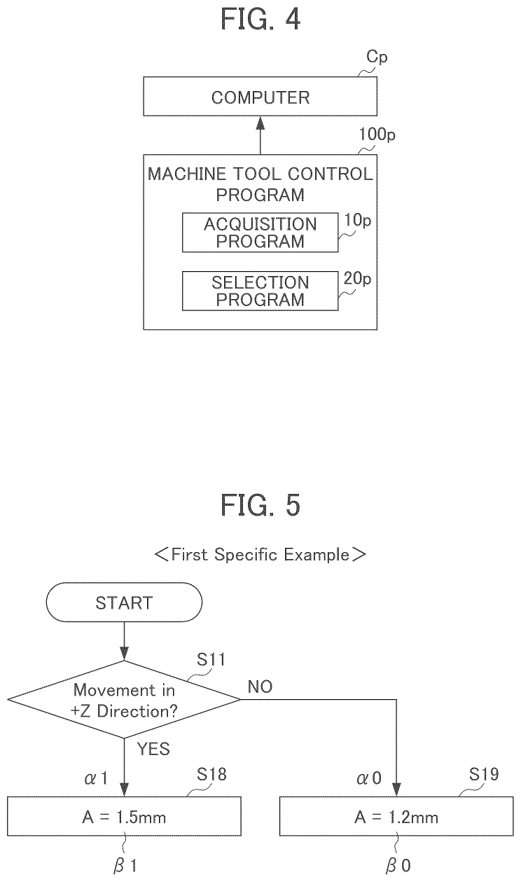

As shown in FIG. 4, the machine tool control device 100 is mainly composed of a computer Cp and a machine tool control program 100p to be read by the computer Cp. The computer Cp includes, for example, a CPU, RAM, and ROM. The machine tool control program 100p operates in conjunction with the computer Cp to enable the computer Cp to function as the machine tool control device 100. Specifically, the machine tool control program 100p includes an acquisition program 10p for enabling the computer Cp to function as the acquisition unit 10 and a selection program 20p for enabling the computer Cp to function as the selection unit 20.

The following describes specific examples of the selection of a vibration condition β based on a cutting condition α with reference to FIGS. 5 to 15.

First, a first specific example shown in FIG. 5 will be described. In the first specific example, the first cutting condition α1 is met if the direction of the relative Z-axis movement is the positive Z direction. Based on the first vibration condition β1 associated with this first cutting condition α1, the amplitude A is set to 1.5 mm. If the cutting condition α1 is not met, then the basic association information αβ0 is met. Based on the basic vibration condition β0 associated with this basic association information αβ0, the amplitude A is set to 1.2 mm.

In the first specific example, it is first determined in S11 whether or not the direction of the relative Z-axis movement is the positive Z direction. If the result of the determination is positive, the first cutting condition α1 is recognized to be met, and accordingly the process advances to S18 to employ the first vibration condition β1 and set the amplitude A to 1.5 mm. If the result of the determination in S11 is negative, the basic cutting condition α0 is recognized to be met, and accordingly the process advances to S19 to employ the basic vibration condition β0 and set the amplitude A to 1.2 mm.

The first specific example can be suitably employed, for example, in a case where the direction of the relative Z-axis movement being set to the positive Z direction makes it difficult to break up the chips. Specific examples thereof include a case where one of directions of front saw and back saw is the positive Z direction and the other is the negative Z direction.

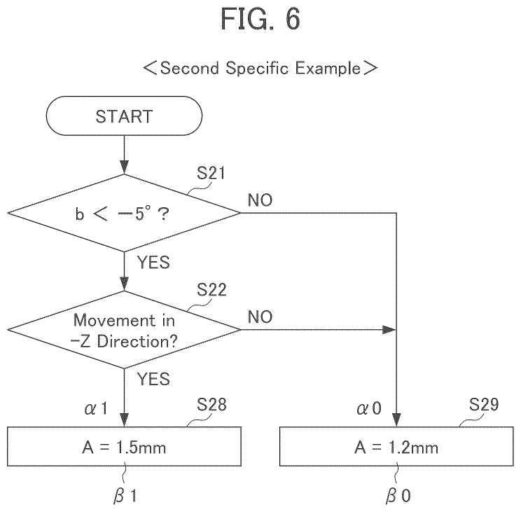

Next, a second specific example shown in FIG. 6 will be described. In the second specific example, the first cutting condition α1 is met if the tool angle b is equal to or less than −5° and the direction of the relative Z-axis movement is the negative Z direction. That is, an “AND” logical operation is performed in this specific example. Based on the first vibration condition β1 associated with this first cutting condition α1, the amplitude A is set to 1.5 mm. If the cutting condition α1 is not met, then the basic cutting condition α0 is met. Based on the basic vibration condition β0 associated with this basic cutting condition α0, the amplitude A is set to 1.2 mm.

In the second specific example, it is first determined in S21 whether or not the tool angle b is equal to or less than −5°. If the result of the determination is positive, the process advances to S22 and it is determined whether or not the direction of the relative Z-axis movement is the negative Z direction. If the result of the determination is positive, the first cutting condition α1 is recognized to be met, and accordingly the process advances to S28 to employ the first vibration condition β1 and set the amplitude A to 1.5 mm. If the result of the determination in S11 or S22 is negative, the basic cutting condition α0 is recognized to be met, and accordingly the process advances to S29 to employ the basic vibration condition β0 and set the amplitude A to 1.2 mm.

The second specific example can be suitably employed, for example, in a case where the tool angle b being set to equal to or less than −5° and the direction of the relative Z-axis movement being set to the negative Z direction make it difficult to break up the chips.

In this specific example, the condition in S21 described above may be interpreted as a “first part of the first cutting condition” and the condition in S22 described above may be interpreted as a “second part of the first cutting condition”. In this case, the first cutting condition α1 is met on condition that both the first part of the first cutting condition and the second part of the first cutting condition are met. Such a configuration can be suitably employed in a case where it is desirable to employ a predetermined vibration condition β only when two conditions are both met.

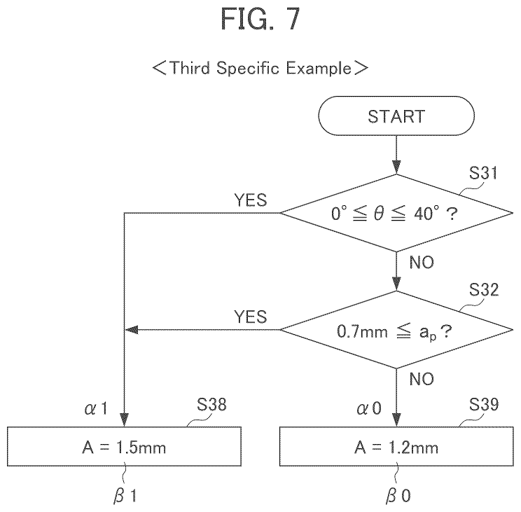

Next, a third specific example shown in FIG. 7 will be described. In the third specific example, the first cutting condition α1 is met if at least one of the following is met: the approach angle θ is 0 to 40° or the depth of cut aₚ is equal to or greater than 0.7 mm. That is, an “OR” logical operation is performed in this specific example. Based on the first vibration condition β1 associated with this first cutting condition α1, the amplitude A is set to 1.5 mm. If the cutting condition α1 is not met, then the basic cutting condition α0 is met. Based on the basic vibration condition β0 associated with this basic cutting condition α0, the amplitude A is set to 1.2 mm.

In the third specific example, it is first determined in S31 whether or not the approach angle θ is 0 to 40°. If the result of the determination is positive, the first cutting condition α1 is recognized to be met, and accordingly the process advances to S38 to employ the first vibration condition β1 and set the amplitude A to 1.5 mm. If the result of the determination in S31 is negative, it is determined in S32 whether or not the depth of cut aₚ is equal to or greater than 0.7 mm. If the result of the determination is positive, the first cutting condition α1 is recognized to be met, and accordingly the process advances to S38 to employ the first vibration condition β1 and set the amplitude A to 1.5 mm. If the result of the determination in S32 is negative, the basic cutting condition α0 is recognized to be met, and accordingly the process advances to S39 to employ the basic vibration condition β0 and set the amplitude A to 1.2 mm.

The third specific example can be suitably employed, for example, in a case where both the approach angle θ being set to 0 to 40° and the depth of cut aₚ being set to equal to or greater than 0.7 mm make it difficult to break up the chips.

In this specific example, the condition in S31 described above may be interpreted as a “first part of the first cutting condition” and the condition in S32 described above may be interpreted as a “second part of the first cutting condition”. In this case, the first cutting condition α1 is met on condition that at least one of the first part of the first cutting condition or the second part of the first cutting condition is met. Such a configuration can be suitably employed in a case where it is desirable to employ a predetermined vibration condition β when at least one of a plurality of conditions is met.

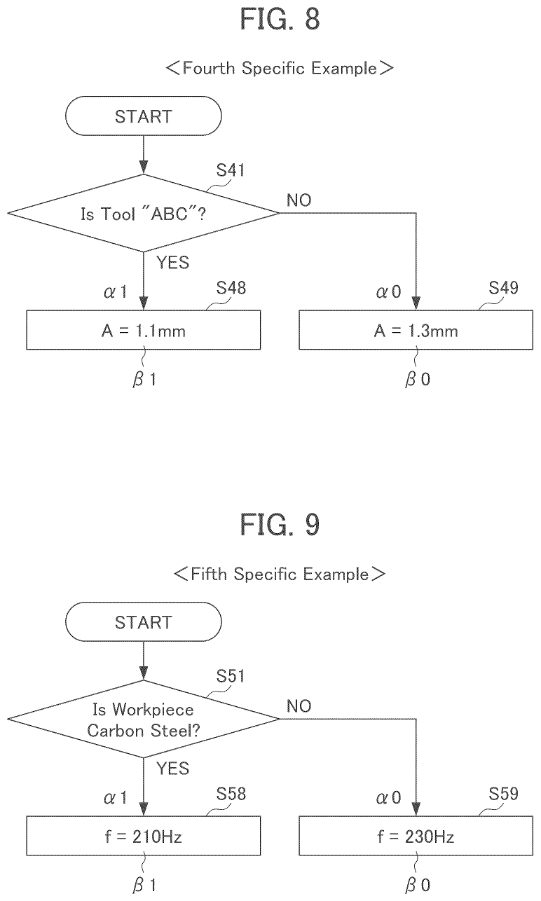

Next, a fourth specific example shown in FIG. 8 will be described. In the fourth specific example, the first cutting condition α1 is met if the cutting tool 220 is “ABC”. Based on the first vibration condition β1 associated with this first cutting condition α1, the amplitude A is set to 1.1 mm. If the cutting condition α1 is not met, then the basic cutting condition α0 is met. Based on the basic vibration condition β0 associated with this basic cutting condition α0, the amplitude A is set to 1.3 mm.

In the fourth specific example, it is first determined in S41 whether or not the cutting tool is “ABC”. If the result of the determination is positive, the first cutting condition α1 is recognized to be met, and accordingly the process advances to S48 to employ the first vibration condition β1 and set the amplitude A to 1.1 mm. If the result of the determination in S41 is negative, the basic cutting condition α0 is recognized to be met, and accordingly the process advances to $49 to employ the basic vibration condition β0 and set the amplitude A to 1.3 mm.

The fourth specific example can be suitably employed, for example, in a case where the cutting tool being “ABC” allows for sufficient chip breaking even with a low amplitude A.

Next, a fifth specific example shown in FIG. 9 will be described. In the fifth specific example, the first cutting condition α1 is met if the workpiece 260 is carbon steel. Based on the first vibration condition β1 associated with this first cutting condition α1, the frequency f is set to 210 Hz. If the cutting condition α1 is not met, then the basic cutting condition α0 is met. Based on the basic vibration condition β0 associated with this basic cutting condition α0, the frequency f is set to 230 Hz.

In the fifth specific example, it is first determined in S51 whether or not the workpiece 260 is carbon steel. If the result of the determination is positive, the first cutting condition α1 is recognized to be met, and accordingly the process advances to S58 to employ the first vibration condition β1 and set the frequency f to 210 Hz. If the result of the determination in S51 is negative, the basic cutting condition α0 is recognized to be met, and accordingly the process advances to S59 to employ the basic vibration condition β0 and set the frequency f to 230 Hz.

The fifth specific example can be suitably employed, for example, in a case where the workpiece 260 being carbon steel makes it difficult to break up the chips, and lowering the frequency f leads to an increase in the amplitude A. For other examples, the fifth specific example can be also suitably employed in a case where a lower frequency f allows for more efficient chip breaking due to the workpiece 260 being carbon steel, and in a case where the workpiece 260 being carbon steel allows for sufficient chip breaking even with a low frequency f.

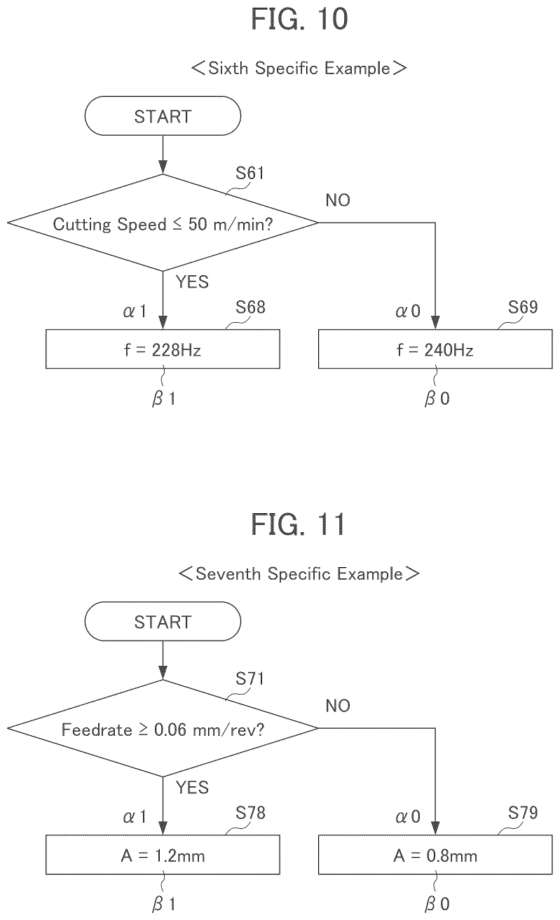

Next, a sixth specific example shown in FIG. 10 will be described. In the sixth specific example, the first cutting condition α1 is met if the cutting speed through the relative movement between the two entities 220 and 260 is equal to or less than 50 m/min. Based on the first vibration condition β1 associated with this first cutting condition α1, the frequency f is set to 0.95 times that in the case of the basic vibration condition β0. If the cutting condition α1 is not met, then the basic cutting condition α0 is met. Based on the basic vibration condition β0 associated with this basic cutting condition α0, the frequency f is set to 240 Hz.

In the sixth specific example, it is first determined in S61 whether or not the cutting speed is equal to or less than 50 m/min. If the result of the determination is positive, the first cutting condition α1 is recognized to be met, and accordingly the process advances to S68 to employ the first vibration condition β1 and set the frequency f to 0.95 times that in the case of the basic vibration condition β0, which in other words is 228 Hz. If the result of the determination in S61 is negative, the basic cutting condition α0 is recognized to be met, and accordingly the process advances to S69 to employ the basic vibration condition β0 and set the frequency f to 240 Hz.

The sixth specific example can be suitably employed, for example, in a case where the cutting speed being set to equal to or less than 50 m/min makes it difficult to break up the chips, and lowering the frequency f leads to an increase in the amplitude A. For other examples, the sixth specific example can be also suitably employed in a case where a lower frequency f allows for more efficient chip breaking due to the cutting speed being set to equal to or less than 50 m/min, and in a case where the cutting speed being set to equal to or less than 50 m/min allows for sufficient chip breaking even with a low frequency f.

Next, a seventh specific example shown in FIG. 11 will be described. In the seventh specific example, the first cutting condition α1 is met if the amount of the relative Z-axis movement per revolution in the relative Z-axis rotation is equal to or greater than 0.06 mm/rev. Based on the first vibration condition β1 associated with this first cutting condition α1, the amplitude A is set to 1.2 mm. If the cutting condition α1 is not met, then the basic cutting condition α0 is met. Based on the basic vibration condition β0 associated with this basic cutting condition α0, the amplitude A is set to 0.8 mm.

In the seventh specific example, it is first determined in S71 whether or not the amount of the relative Z-axis movement is equal to or greater than 0.06 mm/rev. If the result of the determination is positive, the first cutting condition α1 is recognized to be met, and accordingly the process advances to S78 to employ the first vibration condition β1 and set the amplitude A to 1.2 mm. If the result of the determination in S71 is negative, the basic cutting condition α0 is recognized to be met, and accordingly the process advances to S79 to employ the basic vibration condition β0 and set the amplitude A to 0.8 mm.

The seventh specific example can be suitably employed, for example, in a case where the amount of the relative Z-axis movement being set to equal to or greater than 0.06 mm/rev makes it difficult to cut the chips.

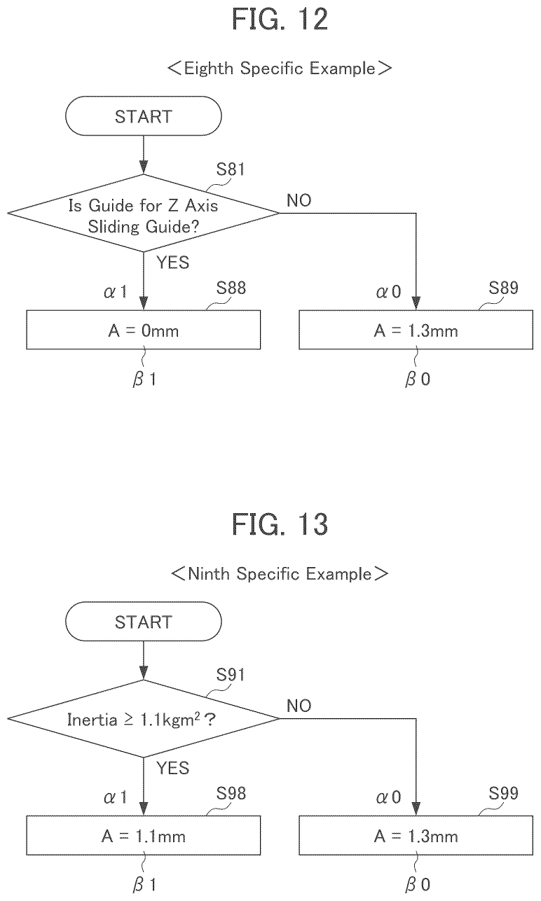

Next, an eighth specific example shown in FIG. 12 will be described. In the eighth specific example, the first cutting condition α1 is met if the guide for the workpiece 260 in the Z direction is a sliding guide. Based on the first vibration condition β1 associated with this first cutting condition α1, the amplitude A is set to 0 mm, which means that no relative vibration is superimposed on the relative movement between the two entities 220 and 260. If the cutting condition α1 is not met, then the basic cutting condition α0 is met. Based on the basic vibration condition β0 associated with this basic cutting condition α0, the amplitude A is set to 1.3 mm.

In the eighth specific example, it is first determined in S81 whether or not the guide for the workpiece 260 in the Z direction is a sliding guide. If the result of the determination is positive, the first cutting condition α1 is recognized to be met, and accordingly the process advances to S88 to employ the first vibration condition β1 and set the amplitude A to 0 mm. If the result of the determination in S81 is negative, the basic cutting condition α0 is recognized to be met, and accordingly the process advances to S89 to employ the basic vibration condition β0 and set the amplitude A to 1.3 mm.

The eighth specific example can be suitably employed, for example, in a case where the guide for the workpiece 260 in the Z direction is not a rolling guide with rollers and the like but a sliding guide, and superimposing relative vibration on the relative movement between the two entities 220 and 260 would result in an overly large load.

Next, a ninth specific example shown in FIG. 13 will be described. In the ninth specific example, the first cutting condition α1 is met if the inertia in the relative Z-axis rotation is equal to or greater than 1.1 kg·m². Based on the first vibration condition β1 associated with this first cutting condition α1, the amplitude A is set to 1.1 mm. If the cutting condition α1 is not met, then the basic cutting condition α0 is met. Based on the basic vibration condition β0 associated with this basic cutting condition α0, the amplitude A is set to 1.3 mm.

In the ninth specific example, it is first determined in S91 whether or not the inertia in the relative Z-axis rotation is equal to or greater than 1.1 kg·m². If the result of the determination is positive, the first cutting condition α1 is recognized to be met, and accordingly the process advances to S98 to employ the first vibration condition β1 and set the amplitude A to 1.1 mm. If the result of the determination in S91 is negative, the basic cutting condition α0 is recognized to be met, and accordingly the process advances to S99 to employ the basic vibration condition β0 and set the amplitude A to 1.3 mm.

The ninth specific example can be suitably employed, for example, in a case where the inertia being set to equal to or greater than 1.1 kg·m² allows for sufficient chip breaking even with a low amplitude A.

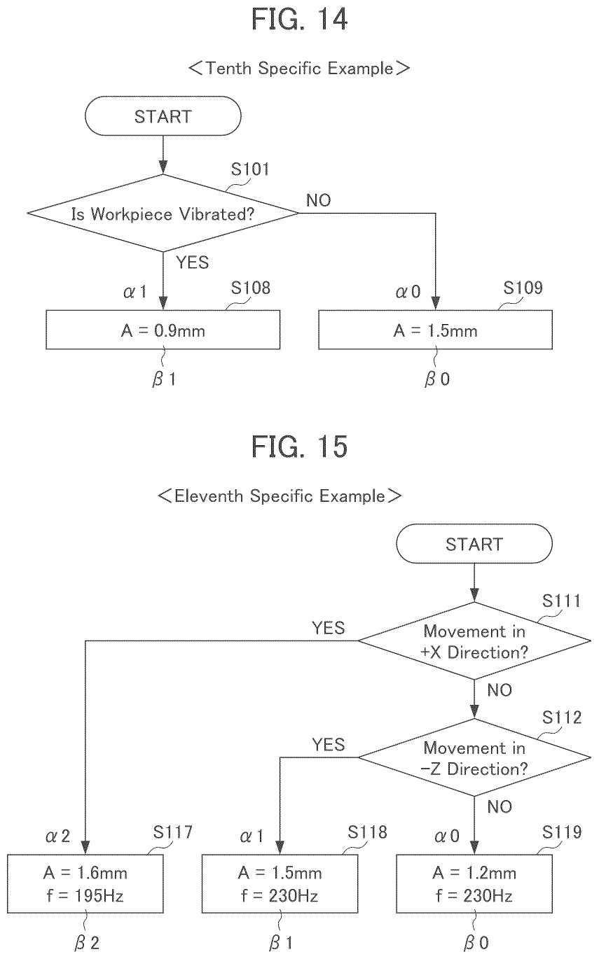

Next, a tenth specific example shown in FIG. 14 will be described. In the tenth specific example, the first cutting condition α1 is met if the workpiece 260 is vibrated for creating relative vibration between the two entities 220 and 260. Based on the first vibration condition β1 associated with this first cutting condition α1, the amplitude A is set to 0.9 mm. If the cutting condition α1 is not met, then the basic cutting condition α0 is met. Based on the basic vibration condition β0 associated with this basic cutting condition α0, the amplitude A is set to 1.5 mm.

In the tenth specific example, it is first determined in S101 whether or not the workpiece 260 is vibrated. If the result of the determination is positive, the first cutting condition α1 is recognized to be met, and accordingly the process advances to S108 to employ the first vibration condition β1 and set the amplitude A to 0.9 mm. If the result of the determination in S101 is negative, the basic cutting condition α0 is recognized to be met, and accordingly the process advances to S109 to employ the basic vibration condition α0 and set the amplitude A to 1.5 mm.

The tenth specific example can be suitably employed, for example, in a case where the workpiece 260 being set to be vibrated requires the amplitude A to be kept low because vibrating the workpiece 260 raises greater concern about damage to the workpiece 260 and the machine tool 200 compared to vibrating the cutting tool 220, and in a case where the workpiece 260 being set to be vibrated allows for sufficient chip breaking even with a low amplitude A.

Next, an eleventh specific example shown in FIG. 15 will be described. In the eleventh specific example, the second cutting condition α2 is met if the direction of the relative X-axis movement is the positive X direction. Based on the second vibration condition β2 associated with this second cutting condition α2, the amplitude A is set to 1.6 mm, and the frequency f is set to 195 Hz. If the second cutting condition α2 is not met, and the direction of the relative Z-axis movement is the negative Z direction, then the first cutting condition α1 is met. Based on the first vibration condition β1 associated with this first cutting condition α1, the amplitude A is set to 1.5 mm, and the frequency f is set to 230 Hz. If neither the second cutting condition α2 nor the first cutting condition α1 is met, then the basic cutting condition α0 is met. Based on the basic vibration condition β0 associated with this basic cutting condition α0, the amplitude A is set to 1.2 mm, and the frequency f is set to 230 Hz.

In the eleventh specific example, it is first determined in S111 whether or not the direction of the relative X-axis movement is the positive X direction. If the result of the determination is positive, the second cutting condition α2 is recognized to be met, and accordingly the process advances to S117 to employ the second vibration condition β2, and set the amplitude A to 1.6 mm and the frequency f to 195. If the result of the determination in S111 is negative, the process advances to S112 and it is determined whether or not the direction of the relative Z-axis movement is the negative Z direction. If the result of the determination is positive, the first cutting condition α1 is recognized to be met, and accordingly the process advances to S118 to employ the first vibration condition β1, and set the amplitude A to 1.5 mm and the frequency f to 230 Hz. If the result of the determination in S112 is negative, the basic cutting condition α0 is recognized to be met, and accordingly the process advances to S119 to employ the basic vibration condition β0, and set the amplitude A to 1.2 mm and the frequency f to 230 Hz.

The eleventh specific example can be suitably employed, for example, in a case where the direction of the relative Z-axis movement being set to the negative Z direction makes it difficult to break up the chips, and the direction of the relative X-axis movement being set to the positive X direction makes it more difficult to break up the chips.

It should be noted that any of the first through eleventh specific examples described above can be implemented in combination with each other. Specifically, for example, the first specific example shown in FIG. 5 and the fifth specific example shown in FIG. 9 may be combined. In this case, it is possible to set the amplitude A based on the direction of the relative Z-axis movement, and it is also possible to set the frequency f based on the type of the workpiece 260.

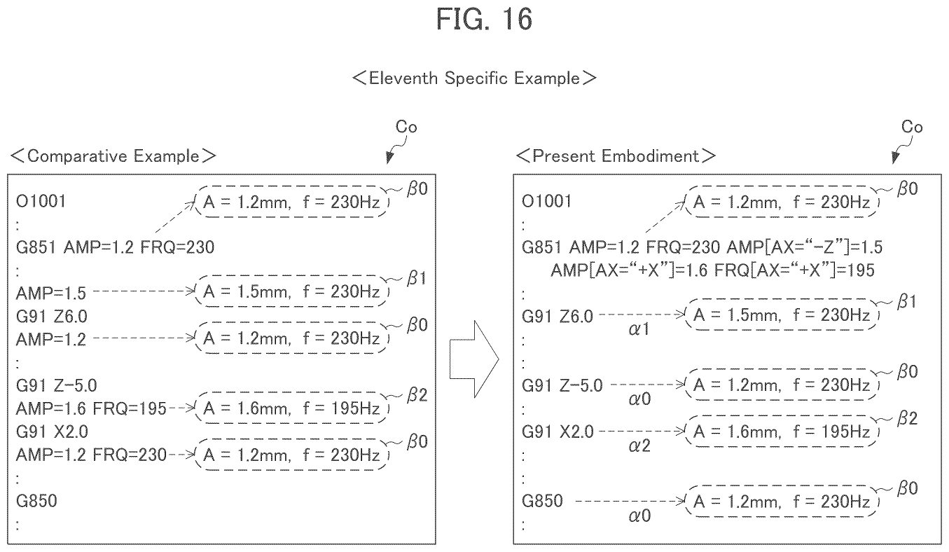

The following describes a specific function of the present embodiment with reference to FIG. 16. The left side in FIG. 16 shows a case where the same setting adjustment as in the eleventh specific example described above is performed by changing the vibration condition β using a program command Co in a comparative example that does not have the acquisition unit 10 or the selection unit 20. By contrast, the right side in FIG. 16 shows the program command Co in a case where the eleventh specific example described above is employed in the present embodiment. More specifically, in FIG. 16, the vibration condition β is switched in the following order: basic vibration condition β0→first vibration condition β1→basic vibration condition β0→second vibration condition β2→basic vibration condition β0.

In the case of the comparative example shown on the left, a command is required each time the vibration condition β is changed. By contrast, in the case of the present embodiment, the vibration condition β is automatically changed based on the selection unit 20 recognizing a change in the cutting condition α from the program command Co. It is therefore possible to change the vibration condition β without a user inputting commands for changing the vibration condition β.

The following summarizes the configurations and effects of the present embodiment.

The selection unit 20 recognizes a cutting condition α set for the cutting operation to be executed and selects a vibration condition β based on the recognized cutting condition α and the association information αβ. The machine tool control device 100 can therefore superimpose just the right relative vibration on the relative movement between the two entities 220 and 260 based on the selected vibration condition β. This configuration helps minimize unnecessary motion in the relative vibration and minimizes damage to the cutting tool 220, the workpiece 260, the machine tool 200, and the like due to the relative vibration. Furthermore, the selection unit 20 automatically selects the vibration condition β associated with the cutting condition α without the user inputting a command for changing the vibration condition β to the program command Co. This configuration therefore helps reduce effort required from the user.

The acquisition unit 10 includes a storage unit 15 that stores therein the association information αβ acquired. Thus, even in a situation where the association information αβ is not available through, for example, a network when needed, the selection unit 20 can select the vibration condition β based on the association information αβ stored in the storage unit 15 without any trouble.

The selection unit 20 recognizes a cutting condition α set for the cutting operation to be executed, based on the program command Co inputted by the user. The selection unit 20 can therefore efficiently recognize a cutting condition α using the program command Co.

### Second Embodiment

Next, a second embodiment will be described. The description of the present embodiment is given based on the first embodiment and focuses on differences therebetween. The description of features that are the same as or similar to those in the first embodiment will be omitted as appropriate.

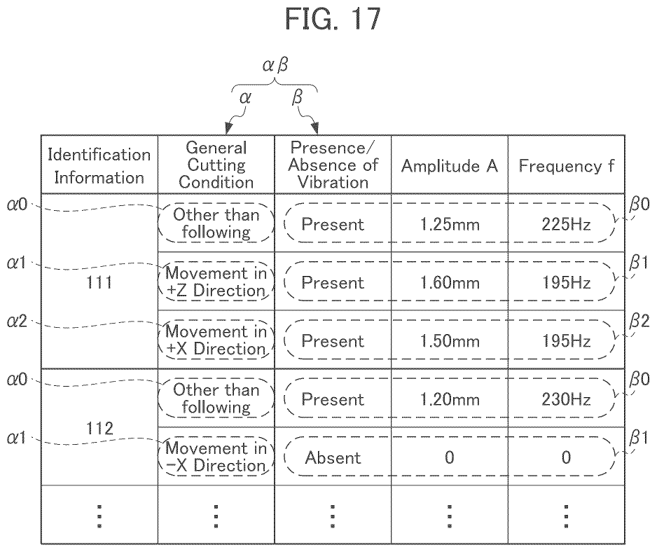

FIG. 17 is a table showing association information αβ in the present embodiment. The cutting condition α includes the type of the cutting tool 220 and a general cutting condition. The type of the cutting tool 220 is recognized based on identification information of the cutting tool 220. Specifically, the selection unit 20 recognizes the cutting tool 220 to be a first tool if “111” is inputted to the program command Co regarding the cutting tool 220, and the selection unit 20 recognizes the cutting tool 220 to be a second tool if “112” is inputted to the program command Co regarding the cutting tool 220. In a similar manner, the cutting tool 220 is recognized to be a “third tool”, a “fourth tool”, and so on if “113”, “114”, and so on are inputted.

A different general cutting condition is set for each type of the cutting tool 220. Specifically, in a case where the cutting tool 220 is the first tool, for example, a basic cutting condition α0, a first cutting condition α1, and a second cutting condition α2 are included as general cutting conditions.

More specifically, in this example, the first cutting condition α1 is met if the direction of the relative Z-axis movement is the positive Z direction. Based on the first vibration condition β1 associated with this first cutting condition α1, the amplitude A is set to 1.60 mm, and the frequency f is set to 195 Hz. If the cutting condition α1 is not met, and the direction of the relative X-axis movement is the positive X direction, then the second cutting condition α2 is met. Based on the second vibration condition β2 associated with this second cutting condition α2, the amplitude A is set to 1.50 mm, and the frequency f is set to 195 Hz. If neither the first cutting condition α1 nor the second cutting condition α2 is met, then the basic cutting condition α0 is met. Based on the basic vibration condition β0 associated with this basic cutting condition α0, the amplitude A is set to 1.25 mm, and the frequency f is set to 225 Hz.

For another example, in a case where the cutting tool 220 is the second tool, basic association information αβ0 different from that in the case where the cutting tool 220 is the first tool and first association information αβ1 different from that in the case where the cutting tool 220 is the first tool are included as general cutting conditions.

More specifically, in this example, the first cutting condition α1 is met if the direction of the relative X-axis movement is the positive X direction. Based on the first vibration condition β1 associated with this first cutting condition α1, no relative vibration is created. If the first cutting condition α1 is not met, then the basic cutting condition α0 is met. Based on the basic vibration condition β0 associated with this basic cutting condition α0, the amplitude A is set to 1.20 mm, and the frequency f is set to 230 Hz.

In a similar manner, general cutting conditions and vibration conditions β respectively associated therewith exist respectively corresponding to a case where the cutting tool is the third tool, a case where the cutting tool is the fourth tool, and so on.

The association information αβ described above may be, for example, obtained from a network or the like or created by the user on his/her own. Specific examples of the latter case include where the machine tool control device 100 displays the table shown in FIG. 17 on a display and the user enters a desired numerical value in each cell of the table.

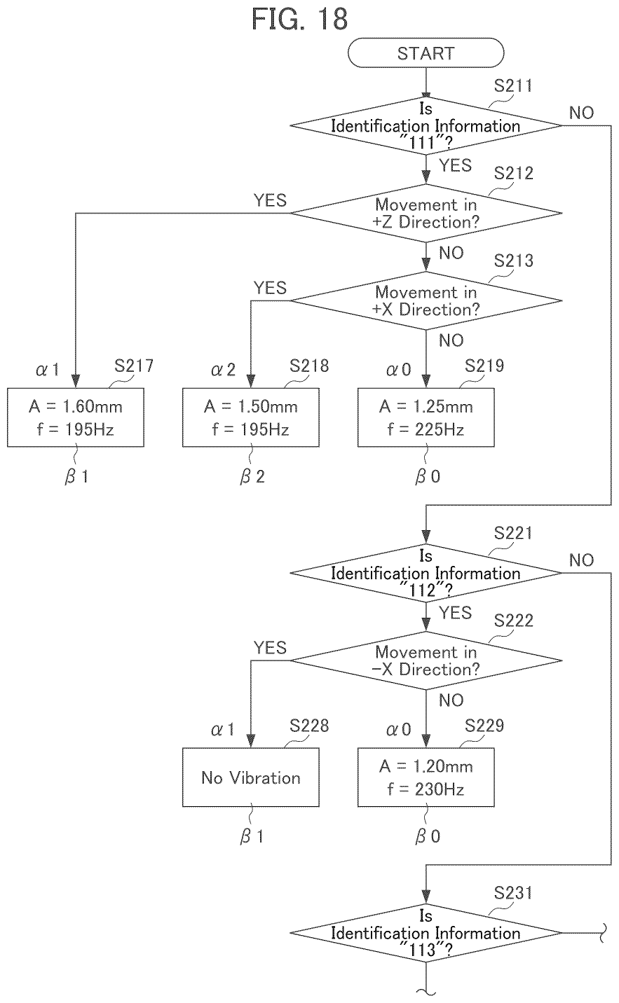

Next, the following describes a flow in the present embodiment with reference to FIG. 18. First, in S211, it is determined whether or not the identification information of the cutting tool 220 is “111”. If the result of the determination is positive, the cutting tool 220 is recognized to be the first tool, and accordingly the process advances to S212 and it is determined whether or not the direction of the relative Z-axis movement is the positive Z direction. If the result of the determination is positive, the first cutting condition α1 in the case of the first tool is recognized to be met, and accordingly the process advances to S217 to employ the first vibration condition β1 in the case of the first tool, and set the amplitude A to 1.60 mm and the frequency f to 195 Hz. If the result of the determination in S212 is positive, the process advances to S213 and it is determined whether or not the direction of the relative X-axis movement is the positive X direction. If the result of the determination is positive, the second cutting condition α2 in the case of the first tool is recognized to be met, and accordingly the process advances to S218 to employ the second vibration condition β2 in the case of the first tool, and set the amplitude A to 1.50 mm and the frequency f to 195 Hz. If the result of the determination in S213 is positive, the basic cutting condition α0 in the case of the first tool is recognized to be met, and accordingly the process advances to S219 to employ the basic vibration condition β0, and set the amplitude A to 1.25 mm and the frequency f to 225 Hz. If the result of the determination back in S211 is negative, the cutting tool 220 is recognized not to be the first tool, and accordingly the process advances to S221.

In S221, it is determined whether or not the identification information is “112”. If the result of the determination is positive, the cutting tool is recognized to be the second tool, and accordingly the process advances to S212 and it is determined whether or not the direction of the relative X-axis movement is the negative X direction. If the result of the determination is positive, the first cutting condition α1 in the case of the second tool is recognized to be met, and accordingly the process advances to S228 to employ the first vibration condition β1 in the case of the second tool and superimpose no relative vibration. If the result of the determination in S222 is negative, the basic cutting condition α0 in the case of the second tool is recognized to be met, and accordingly the process advances to S229 to employ the basic vibration condition β0 in the case of the second tool, and set the amplitude A to 1.20 mm and the frequency f to 230 Hz. If the result of the determination back in S221 is negative, the cutting tool 220 is recognized not to be the second tool, and accordingly the process advances to S231.

The flow then continues for the cases where the cutting tool 220 is the third tool, the fourth tool, and so on.

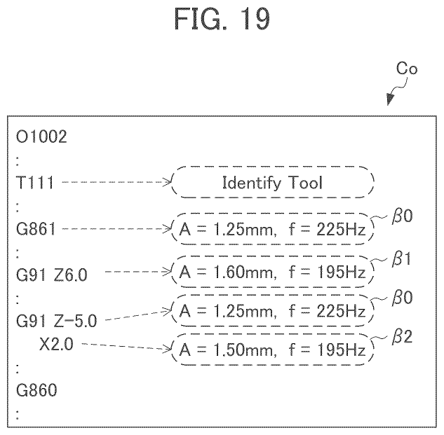

The following describes a specific function of the present embodiment with reference to FIG. 19. In the present embodiment, the selection unit 20 recognizes the type of the cutting tool 220 based on a command indicating the cutting tool 220 in the program command Co, which specifically is based on the identification information such as “111”, “112”, or the like. Thereafter, the selection unit 20 recognizes the general cutting condition based on the subsequent command in the program command Co and selects a vibration condition β based on the recognized general cutting condition.

According to the present embodiment, the selection unit 20 recognizes the type of the cutting tool 220 based on the identification information of the cutting tool 220. The selection unit 20 can therefore recognize the type of the cutting tool 220 easily and efficiently.

Moreover, the cutting condition α includes the type of the cutting tool 220 and a type-by-type general cutting condition set for the type of the cutting tool 220. Accordingly, the selection unit 20 can first differentiate tools based on the type of the cutting tool 220, and then select a specific vibration condition β based on the general cutting condition. This configuration makes it possible to efficiently select an optimal vibration condition β.

### Other Embodiments

The embodiments described above may be, for example, modified as described below. If the association information αβ is available through, for example, a network at any time, the storage unit 15 may be omitted and the necessary association information of may be acquired from the network when needed.

The storage unit 15 in the computer Cp may be omitted, and the storage unit 15 is provided in, for example, a cloud. A dedicated machine tool control device 100 may be provided instead of the machine tool control device 100 mainly composed of the computer Cp and the machine tool control program 100p.

### EXPLANATION OF REFERENCE NUMERALS

10: Acquisition unit
10p: Acquisition program
15: Storage unit
20: Selection unit
20p: Selection program
100: Machine tool control device
100p: Machine tool control program
200: Machine tool
220: Cutting tool
260: Workpiece
αβ: Association information
αβ0: Basic association information
αβ1: First association information
αβ2: Second association information
α0: Basic cutting condition
α1: First cutting condition
α2: Second cutting condition
β0: Basic vibration condition
β1: First vibration condition
β2: Second vibration condition

1. A machine tool control device for causing a machine tool to execute a cutting operation for cutting a workpiece by creating relative movement between the workpiece and a cutting tool, and also to break up chips by superimposing relative vibration between the workpiece and the cutting tool on the relative movement, and thus generating air cutting, the machine tool control device comprising:
an acquisition unit that acquires association information indicating associations between cutting conditions each indicating a factor of the cutting operation and vibration conditions each including at least one of an amplitude or a frequency of the relative vibration; and
a selection unit that recognizes a cutting condition set for the cutting operation to be executed and selects a vibration condition from among the vibration conditions based on the recognized cutting condition and the association information, wherein
the relative vibration is superimposed on the relative movement based on the selected vibration condition.

2. The machine tool control device according to claim 1, wherein
the cutting conditions each include at least one of a feed direction in the relative movement, a feedrate in the relative movement, or a cutting speed of the workpiece.

3. The machine tool control device according to claim 1, wherein
the cutting conditions each include at least one of a relative posture of the cutting tool with respect to the workpiece, a relative angle of a cutting edge of the cutting tool with respect to the workpiece, or a depth of cut of the cutting tool with respect to the workpiece.

4. The machine tool control device according to claim 1, wherein
the cutting conditions each include at least one of a type of the cutting tool, a type of the workpiece, or a mode of the machine tool.

5. The machine tool control device according to claim 1, wherein
the acquisition unit includes a storage unit that stores therein the acquired association information, and
the selection unit selects a vibration condition from among the vibration conditions based on the stored association information.

6. The machine tool control device according to claim 1, wherein
the machine tool control device controls the machine tool based on a program command inputted by a user, and
the selection unit recognizes a cutting condition set for the cutting operation to be executed, based on the inputted program command.

7. The machine tool control device according to claim 1, wherein
the cutting conditions each include a type of the cutting tool, and
the selection unit recognizes a type of the cutting tool based on identification information of the cutting tool.

8. The machine tool control device according to claim 1, wherein
the cutting conditions each include a type of the cutting tool and a type-by-type general cutting condition set for the type.

9. The machine tool control device according to claim 1, wherein
the association information includes first association information that associates a predetermined first cutting condition as one of the cutting conditions with a predetermined first vibration condition as one of the vibration conditions, and
the first cutting condition is met on condition that both a first part of the first cutting condition and a second part of the first cutting condition are met, the first part of the first cutting condition being a predetermined condition, the second part of the first cutting condition being another predetermined condition that is different from the first part of the first cutting condition.

10. The machine tool control device according to claim 1, wherein
the association information includes first association information that associates a predetermined first cutting condition as one of the cutting conditions with a predetermined first vibration condition as one of the vibration conditions, and
the first cutting condition is met on condition that at least one of a first part of the first cutting condition or a second part of the first cutting condition is met, the first part of the first cutting condition being a predetermined condition, the second part of the first cutting condition being another predetermined condition that is different from the first part of the first cutting condition.

11. A non-transitory computer-readable storage medium storing a machine tool control program for enabling a computer to function as a machine tool control device for causing a machine tool to execute a cutting operation for cutting a workpiece by creating relative movement between the workpiece and a cutting tool, and also to break up chips by superimposing relative vibration between the workpiece and the cutting tool on the relative movement, and thus generating air cutting, the machine tool control program being configured to further enable the computer to function as:
an acquisition unit that acquires association information indicating associations between cutting conditions each indicating a factor of the cutting operation and vibration conditions each including at least one of an amplitude or a frequency of the relative vibration; and
a selection unit that recognizes a cutting condition set for the cutting operation to be executed and selects a vibration condition from among the vibration conditions based on the recognized cutting condition and the association information, wherein
the relative vibration is superimposed on the relative movement based on the selected vibration condition.
